(19) United States
(12) Patent Application Publication
(10) Pub. No.: US 2016/0019658 A1
(43) Pub. Date: Jan. 21, 2016

(54) ANALYTICAL FRAMEWORK FOR MEASURING IMPACT OF SOCIAL BUSINESS COLLABORATION

(71) Applicant: International Business Machines Corporation, Armonk, NY (US)

(72) Inventor: Nikolay Kadochnikov, Batavia, IL (US)

(21) Appl. No.: 14/335,167

(22) Filed: Jul. 18, 2014

(51) Int. Cl. G06Q 50/00; G06Q 10/00

(52) U.S. Cl. CPC G06Q 50/01; G06Q 10/00

(57) ABSTRACT

A tool for recommending social channel usage to achieve a targeted outcome. The tool determines, by one or more computer processors, a plurality of social channel usage information for one or more employees. The tool determines, by one or more computer processors, a plurality of outcome information for the one or more employees. The tool determines, by one or more computer processors, based, at least in part, on the plurality of social channel usage information and the plurality of outcome information for the one or more employees, one or more analytical models. The tool determines, by one or more computer processors, based, at least in part, on the one or more analytical models, one or more recommendations to achieve a targeted outcome.

### BACKGROUND OF THE INVENTION

The present invention relates generally to social computing, and more particularly to a social business measurement and optimization framework.

Following the success of online social networking, organizations around the world are increasingly looking to social business models to enable effective collaboration and communication between their globally dispersed employees. Organizations are looking to leverage intra-organizational social media tools to increase employee engagement, effectiveness and productivity, as well as foster closer relationships with their clients and business partners. Employees are encouraged to become more involved in social networking

### SUMMARY

Aspects of an embodiment of the present invention disclose a method, a system, and a computer program product for recommending social channel usage to achieve a targeted outcome. The method includes determining, by one or more computer processors, a plurality of social channel usage information for one or more employees. The method further includes determining, by one or more computer processors, a plurality of outcome information for the one or more employees. The method further includes determining, by one or more computer processors, based, at least in part, on the plurality of social channel usage information and the plurality of outcome information for the one or more employees, one or more analytical models. The method further includes determining, by one or more computer processors, based, at least in part, on the one or more analytical models, one or more recommendations to achieve a targeted outcome.

### BRIEF DESCRIPTION OF THE SEVERAL VIEWS OF THE DRAWINGS

FIG. 1 is a functional block diagram illustrating a data processing environment, generally designated 100, in accordance with an embodiment of the present invention.

FIG. 2 is a flowchart of an exemplary process flow, generally designated 200, of an optimization program for optimizing social channel usage to achieve a targeted outcome, in accordance with an embodiment of the present invention.

FIG. 3 depicts a screenshot of an exemplary analytical model, generally designated 300, for determining statistical significance between social channel usage and outcome information, in accordance with an embodiment of the present invention.

FIG. 4 is a block diagram, generally designated 400, depicting components of a data processing system (such as server 104 of FIG. 1), in accordance with an embodiment of the present invention.

### DETAILED DESCRIPTION

Embodiments of the present invention recognize that while intentions to increase efficiency of collaboration across social channels are well understood, organizations lack data-driven insights and analytical techniques to achieve these objectives.

Embodiments of the present invention provide the capability to determine an optimal balance between productivity and social business interaction. Embodiments of the present invention further provide the capability to enable organizations to maximize the value of social business collaboration by leveraging analytical frameworks and optimization techniques to determine social channel usage profiles that align social channel usage with targeted organizational goals.

Implementation of such embodiments can take a variety of forms, and exemplary implementation details are discussed subsequently with reference to the Figures.

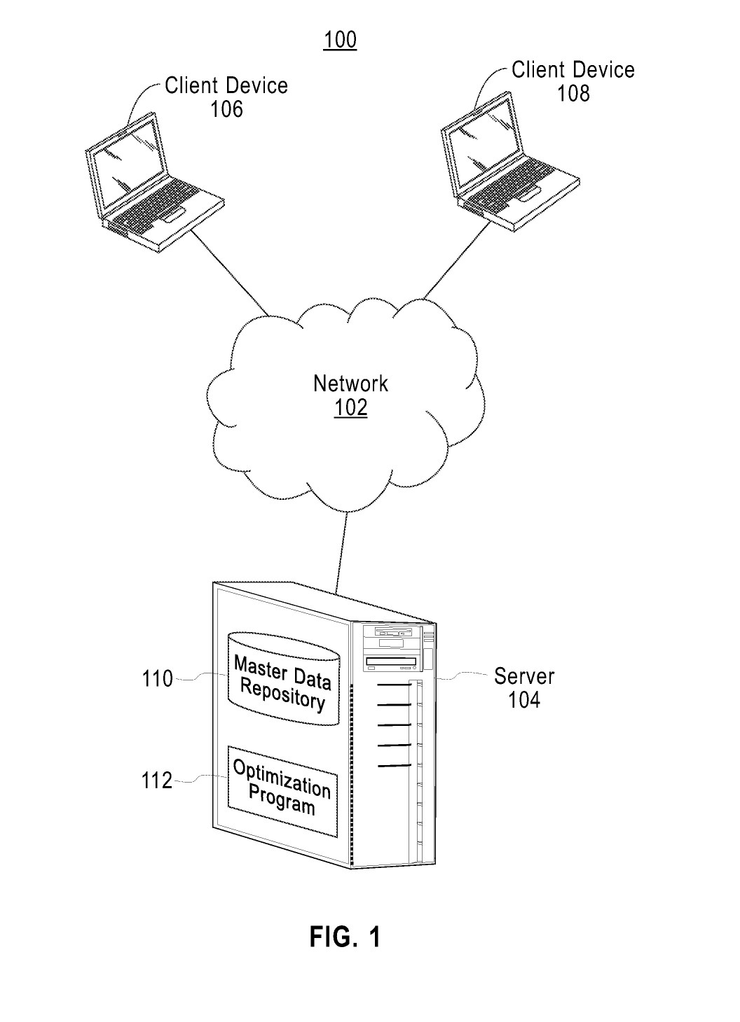

The present invention will now be described in detail with reference to the Figures. FIG. 1 is a functional block diagram illustrating a data processing environment, generally designated 100, in accordance with an embodiment of the present invention. FIG. 1 provides only an illustration of one implementation and does not imply any limitations with regard to the environments in which different embodiments can be implemented. Many modifications to the depicted environment can be made by those skilled in the art without departing from the scope of the invention as recited by the claims. Data processing environment 100 includes network 102, server 104, and multiple client devices, such as client device 106 and client device 108.

In the exemplary embodiment, network 102 is the Internet representing a worldwide collection of networks and gateways that use TCP/IP protocols to communicate with one another. Network 102 can include wire cables, wireless communication links, fiber optic cables, routers, switches and/or firewalls. Server 104, client device 106, and client device 108 are interconnected by network 102. Network 102 can be any combination of connections and protocols capable of supporting communications between server 104, client device 106, client device 108 and optimization program 112. Network 102 can also be implemented as a number of different types of networks, such as an intranet, a local area network (LAN), a virtual local area network (VLAN), or a wide area network (WAN). FIG. 1 is intended as an example and not as an architectural limitation for the different embodiments.

In the exemplary embodiment, server 104 can be, for example, a server computer system such as a management server, a web server, or any other electronic device or computing system capable of sending and receiving data. In another embodiment, server 104 can be a data center, consisting of a collection of networks and servers providing an IT service, such as virtual servers and applications deployed on virtual servers, to an external party. In another embodiment, server 104 represents a “cloud” of computers interconnected by one or more networks, where server 104 is a computing system utilizing clustered computers and components to act as a single pool of seamless resources when accessed through network 102. This is a common implementation for data centers in addition to cloud computing applications.

In the exemplary embodiment, server 104 includes master data repository 110 for storing social channel usage information and outcome information for one or more employees in an organization. In the exemplary embodiment, social channel usage information includes input information across one or more social business channels (e.g., Wiki, blogs, forums, social profiles, communities, file sharing, social networks, etc.) used within the organization. For example, social channel usage information can include, without limitation, one or more files downloaded, one or more profiles tagged, one or more forum replies, one or more blog entries, one or more blog entries viewed, one or more forums created, one or more posts, one or more files shared, one or more searches, and one or more profiles managed, etc. In the exemplary embodiment, outcome information includes targeted outcomes for areas within the organization that the organization wants to improve through the help of optimized social business. For example, outcome information can include, without limitation, customer service, innovation, revenue growth, and patent filings, etc. In the exemplary embodiment, outcome information can be associated with a specific employee, such that, for example, the organization can identify a name of an employee who filed a patent or a name of an employee who left the organization. In another embodiment, outcome information can be associated with one or more organizational identifiers, such as, for example, a specific business unit within the organization, a specific geography, and a specific work site, etc.

In the exemplary embodiment, server 104 includes optimization program 112 for optimizing social channel usage to achieve a targeted organizational outcome. Optimization program 112 creates an analytical framework to determine the impact of social business collaboration (i.e., a collection of social channels used, such as a blog, a forum, a profile, a post, etc.) on organizational goals, and based, at least in part, on one or more models measuring the impact of each of the social channels used against a targeted organizational outcome, determines one or more recommendations for social channel usage to achieve the targeted organizational outcome. In the exemplary embodiment, optimization program 112 is capable of communicating with master data repository 110 to retrieve social channel usage data and outcome information for the one or more employees in the organization.

In the exemplary embodiment, optimization program 112 operates on a central server, such as server 104, and can be utilized by one or more client devices, such as client device 106 and client device 108, for example, where client device 106 is utilized by a manager or client device 108 is an administrator. In another embodiment, optimization program 112 can be a software-based program, downloaded from a central server, such as server 104, and installed on one or more client devices, such as client device 106 and client device 108. In yet another embodiment, optimization program 112 can be utilized as a software service provided by a third-party (not shown).

In the exemplary embodiment, client device 106 and client device 108 are clients to server 104 and can be, for example, a desktop computer, a laptop computer, a tablet computer, a personal digital assistant (PDA), a smart phone, a thin client, or any other electronic device or computing system capable of communicating with server 104 through network 102. For example, client device 106 can be a desktop computer utilized by a manager in an organization to connect with server 104 to execute optimization program 112.

In an alternate embodiment, client device 106 and client device 108 can be any wearable electronic device, including wearable electronic devices affixed to eyeglasses and sunglasses (e.g., Google Glass®), wristwatches, clothing, wigs, and the like, capable of sending, receiving, and processing data. For example, client device 106 and client device 108 can be a wearable electronic device, such as a wristwatch, capable of communicating with server 104 to execute optimization program 112.

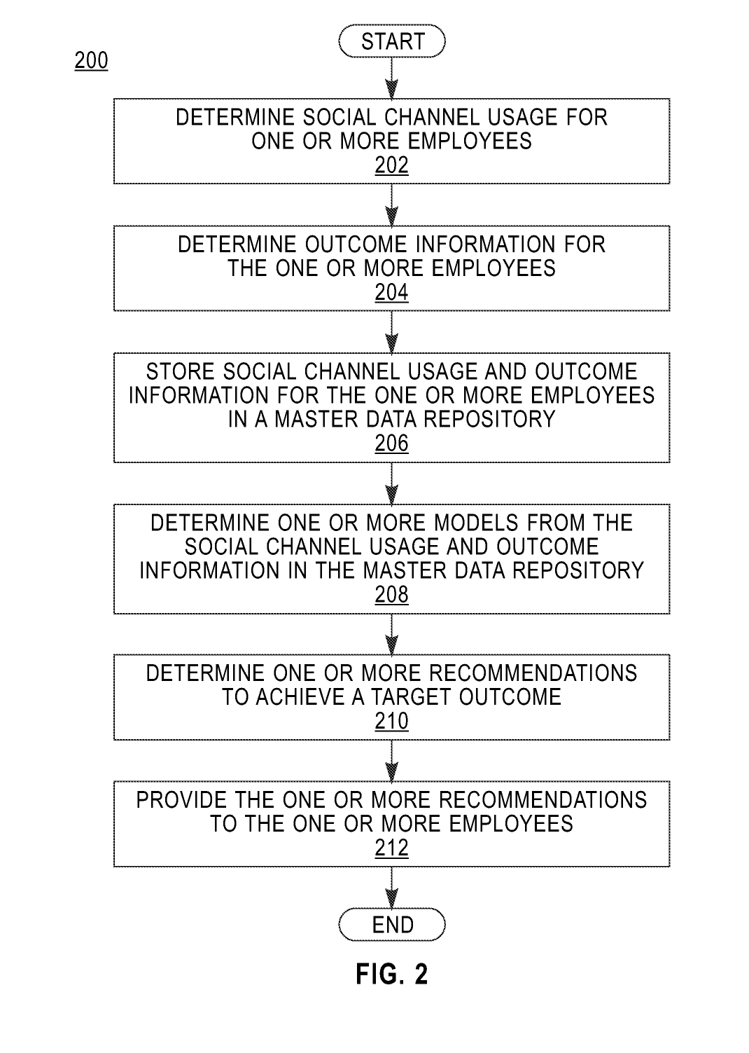

FIG. 2 is a flowchart of an exemplary process flow, generally designated 200, of optimization program 112 for optimizing social channel usage to achieve a targeted outcome, in accordance with an embodiment of the present invention.

Optimization program 112 determines social channel usage for one or more employees (202). In the exemplary embodiment, optimization program 112 determines social channel usage for one or more employees in an organization by utilizing basic data mining techniques to retrieve input information, including, without limitation, a number and a frequency of file shares, a number and a frequency of status updates, a number and a frequency of wiki posts, and a number of forums created, a number and a frequency of “likes”, etc., across one or more social business channels including, without limitation, a social networking website, a blog, a community page, a forum, and a file sharing database, etc., used within the organization. In one embodiment, social channel usage can occur via one or more client devices, such as client device 106 and client device 108. For example, when an employee submits a blog entry from a smart phone, or updates an employee profile from a wearable electronic device affixed to eyeglasses, social channel usage occurs.

Optimization program 112 determines outcome information for the one or more employees (204). In the exemplary embodiment, optimization program 112 determines outcome information for the one or more employees in the organization by utilizing data mining techniques, such as generalized linear modeling, to retrieve output information, including, without limitation, profitability, innovation, revenue, employee retention, deal win-loss ratio, and employee ratings, etc., across one or more areas including, without limitation, a specific geographic location, a specific business unit, and specific sites, etc., within the organization.

In response to determining the social channel usage and the outcome information for the one or more employees, optimization program 112 stores social channel usage and outcome information for the one or more employees in a master data repository (206). In the exemplary embodiment, optimization program 112 stores the social channel usage and outcome information for the one or more employees in a master data repository, such as master data repository 110. In the exemplary embodiment, optimization program 112 stores the social channel usage for each of the one or more employees with a unique identifier, such as a personal ID associated with each of the one or more employees. For example, a personal ID can be an employee email address or an employee identification number. In the exemplary embodiment, optimization program 112 stores the outcome information for each of the one or more employees as personally identifiable outcomes, such as a number of patents filed, sales opportunity win-loss ratio, and an employee rating, etc., and as non-personally identifiable outcomes, such as profitability, revenue, and organizational productivity, etc. For example, non-personally identifiable outcomes can be stored based on an employee's job title, an employee's unit or group within an organization, or an employee's geographical location (e.g., job site, state, country, etc.), whereas personally identifiable outcomes can be stored based on an employee's personal ID, an employee's email address, or an employee's name or serial number. In the exemplary embodiment, optimization program 112 combines the social channel usage and the outcome information for each of the one or more employees, such that the personal ID associated with each of the one or more employees contains all input information associated with social channel usage and the personally identifiable and non-personally identifiable outcome information generated for each of the one or more employees during data mining.

Optimization program 112 determines one or more models from the social channel usage and the outcome information in the master data repository (208). In the exemplary embodiment, optimization program 112 determines the one or more models as generalized predictive linear models trained to predict a desired outcome (e.g., a quota for yearly sales revenue for a seller, a number of patents held by an inventor, etc.). In the exemplary, optimization program 112 determines one or more model from the social channel usage and the outcome information in the master data repository by retrieving input information and outcome information contained under each of the personal IDs associated with each of the one or more employees. For example, optimization program 112 can retrieve the input information and the outcome information associated with the personal ID “johndoe@us.company.com”. In the exemplary embodiment, in response to retrieving the input information and outcome information for each of the one or more employees, optimization program 112 utilizes a suite of multivariate linear models (i.e., analytical models) to determine a statistical significance and a strength of relationship (i.e., a correlation) for each input and each outcome. The measure of statistical significance and the measure of the strength of relationship establish a baseline for determining a correlation between the use of a particular social channel and a targeted outcome. For example, if a group of employees, such as a group of salespeople, who update their employee profiles and submit blog entries often, have a high win-loss ratio, while salespeople who do not update their profiles and rarely blog have a low win-loss ratio, optimization program 112 can assign a strong statistical significance and strong strength of relationship between the input information (e.g., profile updates and blog entries) and the outcome information (positive win-loss ratio). In the exemplary embodiment, optimization program 112 utilizes the one or more models to score an entire universe of employees. Optimization program 112, based, at least in part, on a plurality of scored results, determines a social profile for a group of employees most likely to achieve a targeted outcome. For example, depending on the number of employees in an organization, the group of employees can be the top ten percent of sellers in a sales business unit. In another example, if a group of employees, such as a group of patent engineers, who update their employee profiles and submit blog entries often, have roughly the same number of patents filed per quarter as patent engineers who do not update their profiles and do not participate in blogs, optimization program 112 can assign a weak statistical significance and weak strength of relationship between the input information (e.g., profile updates and blog entries) and the outcome information (patents filed per quarter). In the exemplary embodiment, determining the measure of statistical significance of social channel usage information includes determining one or more employees who have achieved a targeted outcome, and for each of the one or more employees, determine a combination and a frequency of one or more particular social channels included in their social channel usage. Optimization program 112 deconstructs the social profile for a group of employees most likely to achieve a targeted response to determine common patterns of social business usage among each of the employees in the group. Common characteristics can include, without limitation, a range of usage (i.e., frequency of use) for one or more social channels such as posts, updates, likes, blogs, shares, searches, and read information. For example, if an inventor, having a targeted outcome of at least one patent submission, has achieved their targeted outcome, and the inventor has social channel usage including a combination of files shared and profiles tagged, with the highest frequency of social channel usage occurring with files shared and profiles tagged, then optimization program 112 can determine a high measure of statistical significance to those particular social channels Likewise, optimization program 112 can determine a high strength of relationship between files shared and achieving the targeted outcome, where files shared is a particular social channel used by all inventors who have achieved at least one patent submission.

Optimization program 112 determines one or more recommendations to achieve a target outcome (210). In the exemplary embodiment, optimization program 112 determines one or more recommendations to achieve a targeted response by determining a target outcome and evaluating the one or more models to determine what combination and frequency of social channel usage provides the greatest positive impact towards achieving the targeted outcome. In the exemplary embodiment, optimization program 112 determines a targeted outcome by retrieving one or more business objectives an organization desires to achieve or improve upon through the aide of social channel usage. In one embodiment, optimization program 112 can determine a targeted outcome from outcome information derived from data mining. In another embodiment, optimization program 112 can be configurable to receive one or more targeted outcomes from the organization. For example, an executive of an organization can submit one or more targeted outcomes to optimization program 112 for recommending what combination and frequency of social channel usage provides the greatest positive impact towards achieving the one or more targeted outcomes. In the exemplary embodiment, optimization program 112 compares the social channel usage information for each of the employees in a group of employees (i.e., all employees in an organization) responsible for achieving a targeted outcome against an optimal profile for social channel usage derived from top performers achieving the targeted outcome. In the exemplary embodiment, optimization program 112 determines targeted recommendations to align the social channel usage of each of the employees responsible for achieving the targeted outcome with the social channel usage of those top performers achieving the targeted outcome. In the exemplary embodiment, the one or more recommendations vary based, at least in part, on a social channel used, a targeted outcome, and an area within a particular organization, etc. In the exemplary embodiment, optimization program 112 determines one or more relationships between social channel usage and one or more targeted outcomes, the one or more relationships guiding the one or more recommendations to achieve a targeted outcome. A positive linear relationship between a social channel and an increase in an occurrence of a targeted outcome can support a recommendation of increased frequency in the use of that social channel to achieve the targeted outcome. For example, if a targeted outcome for an inventor in a research unit of an organization is to file 5 patents a year, and if frequent file sharing (i.e., social channel usage) supports a strong statistical significance in inventors having at least 1 patent filed a year, then optimization program 112 can recommend that social channel usage for inventors having the targeted outcome of filing 5 patents a year include frequent file sharing. Similarly, for each social business channel where the usage falls within an optimal range, optimization program 112 determines a recommendation to continue the same level of usage. A negative linear relationship between social channel usage and a decrease in the occurrence of a targeted outcome can support a recommendation of decreasing the frequency of social channel usage to have a positive impact on achieving the targeted outcome. For example, if a targeted outcome for a salesperson is a positive win-loss ratio, and if frequent blog entries, forums created, and profiles updated negatively impacts the salesperson win-loss ratio, then optimization program 112 can recommend that social channel usage for salespersons desiring a positive win-loss ratio decrease blog entries, forums created, and profiles updated. Similarly, for each social business channel where the usage is lower than the optimal range, optimization program 112 determines a recommendation to increase social channel usage by X, where X places the social channel usage within the middle of the optimal range. A bell-shaped curve can support a recommendation of social channel usage that falls within a range provided by the bell-shaped curve. For example, if there exists an optimal range for social channel usage based, at least in part, on a targeted outcome, a bell-shaped curve can suggest the optimal range for the type of social channel usage and the frequency for social channel usage that achieves a targeted outcome, where social channel usage below or above the optimal range can negatively impact achieving the targeted outcome.

Optimization program 112 provides the one or more recommendations to the one or more employees (212). In the exemplary embodiment, optimization program 112 provides the one or more recommendations to the one or more employees through one or more visual interfaces, such as a dashboard, an email, a social usage profile attached to their employee profile, a pop-up window, or by any other suitable means for providing such information to the one or more employees. For example, optimization program 112 can send an email bi-weekly to the one or more employees. The email can include a graph, a chart, a spreadsheet, etc., that provides a summary of the employee's social channel usage, and provides the one or more recommendations to positively impact achieving a targeted outcome. In another embodiment, optimization program 112 can provide the one or more recommendations the one or more employees indirectly by distributing the one or more recommendations to one or more managers for distribution or for review.

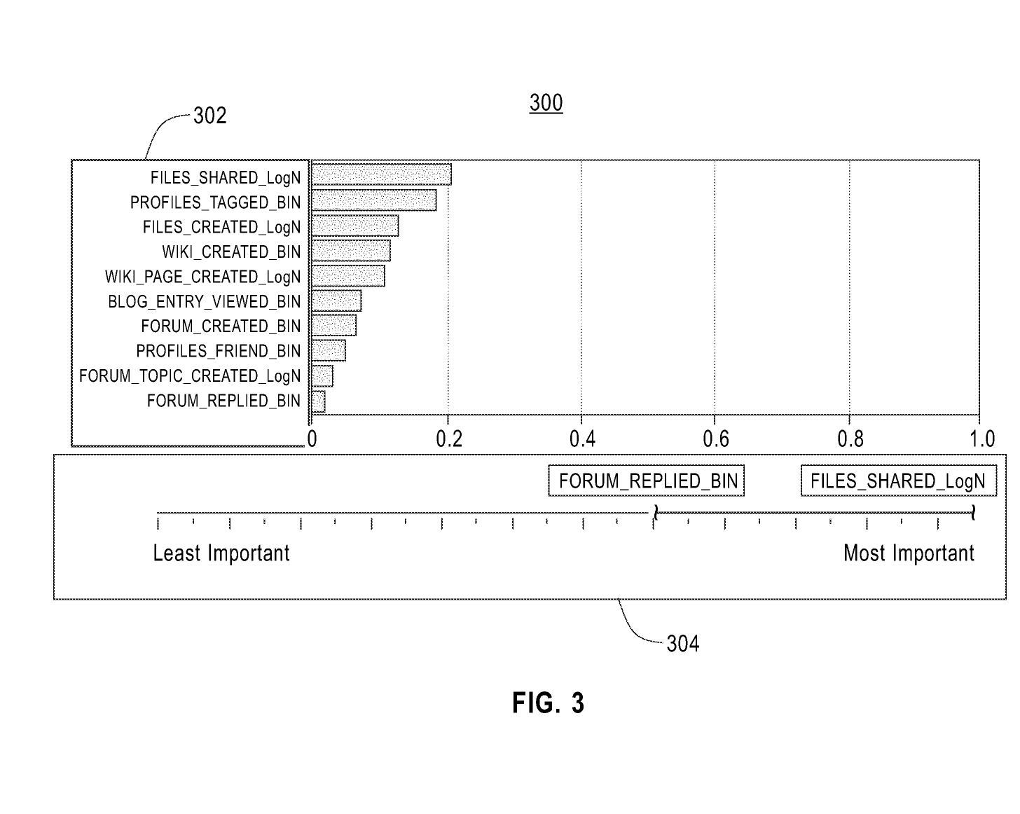

FIG. 3 depicts a screenshot of an exemplary analytical model, generally designated 300, for determining statistical significance between social channel usage and outcome information, in accordance with an embodiment of the present invention.

In the exemplary embodiment, optimization program 112 determines one or more models from information including, without limitation, social channel usage 302, a statistical significance, a correlation, a strength of a statistical relationship, etc., and a ranked significance 304, based, at least in part, on the statistical significance and the strength of the statistical relationship between social channel usage 302 and a targeted outcome. In the exemplary embodiment, one or more predictor variables within in the one or more models include a pool of social business indicators (i.e., frequency of usage), generally transformed to maximize normality and correlation with one or more targeted outcomes. For example, analytical model 300 shows social channel usage 302, including a plurality of top predictors, such as files shared and profiles tagged, with a relative statistical significance for each of the plurality of top predictors, for predicting likelihood of having at least one patent submission (i.e., a targeted outcome). Ranked significance 304 shows the importance of the plurality of top predictors; files shared from social channel usage 302 shows the strongest statistical significance (i.e., greatest positive impact) towards achieving at least one patent submission. Optimization program 112 can determine from analytical model 300 that a recommendation for social channel usage including the plurality of top predictors from social channel usage 302 can have the greatest positive impact on achieving at least one patent submission.

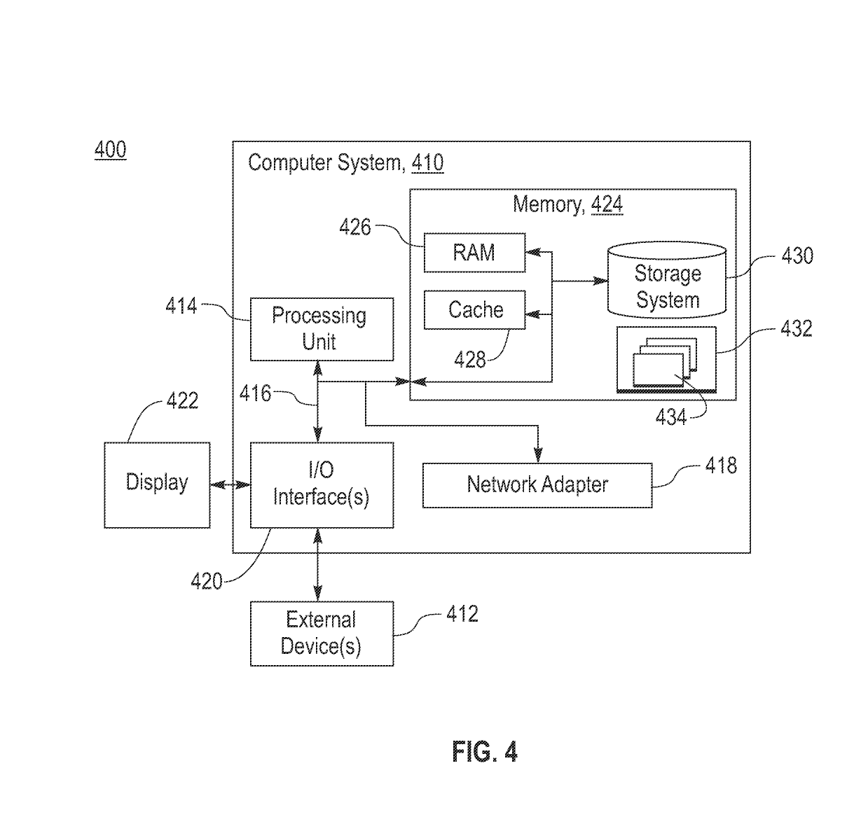

FIG. 4 is a block diagram, generally designated 400, depicting components of a data processing system (such as server 104 of data processing environment 100), in accordance with an embodiment of the present invention. It should be appreciated that FIG. 4 provides only an illustration of one implementation and does not imply any limitations with regard to the environments in that different embodiments can be implemented. Many modifications to the depicted environment can be made.

In the illustrative embodiment, server 104 in data processing environment 100 is shown in the form of a general-purpose computing device. The components of computer system 410 can include, but are not limited to, one or more processors or processing unit 414, memory 424, and bus 416 that couples various system components including memory 424 to processing unit 414.

Bus 416 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 410 typically includes a variety of computer system readable media. Such media can be any available media that is accessible by computer system 410, and it includes both volatile and non-volatile media, removable and non-removable media.

Memory 424 can include computer system readable media in the form of volatile memory, such as random access memory (RAM) 426 and/or cache memory 428. Computer system 410 can further include other removable/non-removable, volatile/non-volatile computer system storage media. By way of example only, storage system 430 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 416 by one or more data media interfaces. As will be further depicted and described below, memory 424 can include at least one computer program product having a set (e.g., at least one) of program modules that are configured to carry out the functions of embodiments of the invention.

Program/utility 432, having one or more sets of program modules 434, can be stored in memory 424 by way of example, and not limitation, as well as an operating system, one or more application programs, other program modules, and program data. Each of the operating systems, one or more application programs, other program modules, and program data, or some combination thereof, can include an implementation of a networking environment. Program modules 434 generally carry out the functions and/or methodologies of embodiments of the invention as described herein. Computer system 410 can also communicate with one or more external devices 412 such as a keyboard, a pointing device, a display 422, etc., or one or more devices that enable a user to interact with computer system 410 and any devices (e.g., network card, modem, etc.) that enable computer system 410 to communicate with one or more other computing devices. Such communication can occur via Input/Output (I/O) interface(s) 420. Still yet, computer system 410 can communicate with one or more networks such as a local area network (LAN), a general wide area network (WAN), and/or a public network (e.g., the Internet) via network adapter 418. As depicted, network adapter 418 communicates with the other components of computer system 410 via bus 416. It should be understood that although not shown, other hardware and software components, such as microcode, device drivers, redundant processing units, external disk drive arrays, RAID systems, tape drives, and data archival storage systems can be used in conjunction with computer system 410.

The present invention can be a system, a method, and/or a computer program product. The computer program product can include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A method for recommending social channel usage to achieve a targeted outcome, the method comprising the steps of:
determining a plurality of social channel usage information for one or more employees;
determining a plurality of outcome information for the one or more employees;
determining, based, at least in part, on the plurality of social channel usage information and the plurality of outcome information for the one or more employees, one or more analytical models, wherein the one or more analytical models indicate patterns of social business usage for one or more employees achieving a targeted outcome; and
determining, based, at least in part, on the one or more analytical models, one or more recommendations to achieve the targeted outcome,
wherein the steps are carried out by one or more computer processors.

2. The method of claim 1, wherein determining a plurality of social channel usage information, further comprises:
retrieving, by one or more computer processors, a plurality of input information across one or more social business channels; and
storing, by one or more computer processors, the plurality of input information across the one or more social business channels in a master data repository, wherein the plurality of input information is stored with a unique identifier associated with each of the one or more employees.

3. The method of claim 1, wherein determining a plurality of outcome information, further comprises:
retrieving, by one or more computer processors, a plurality of output information across one or more areas within an organization; and
storing, by one or more computer processors, the plurality of output information across the one or more areas within the organization in the master data repository, wherein the plurality of output information is stored with the unique identifier associated with each of the one or more employees.

4. The method of claim 1, wherein determining one or more analytical models, further comprises:
retrieving, by one or more computer processors, the plurality of social channel usage information and the plurality of outcome information contained under the unique identifier for each of the one or more employees from the master data repository;
determining, by one or more computer processors, a measure of a statistical significance of the plurality of social channel usage information relative to the plurality of outcome information;
determining, by one or more computer processors, a measure of a strength of relationship between the plurality of social channel usage information and the plurality of outcome information; and
determining, by one or more computer processors, based, at least in part, on the measure of the statistical significance and the measure of the strength of relationship, a correlation between the use of a particular social channel and a targeted outcome.

5. The method of claim 1, wherein determining one or more recommendations to achieve a targeted outcome, further comprises determining, by one or more computer processors, based, at least in part, on the one or more analytical models, a combination and a frequency of social channel usage that provides a positive impact towards achieving a targeted outcome.

6. The method of claim 5, wherein determining a combination and a frequency of social channel usage, further comprises determining, by one or more computer processors, one or more relationships between a type of social channel usage and the targeted outcome, including one or more of:
a positive linear relationship between the type of social channel usage and an increase in an occurrence of the targeted outcome, wherein the positive linear relationship can support a recommendation of increasing a frequency of the type of social channel usage to achieve the targeted outcome;
a negative linear relationship between social channel usage and a decrease in the occurrence of the targeted outcome, wherein the negative linear relationship supports a recommendation of decreasing the frequency of the type of social channel usage to achieve the targeted outcome; and
a bell-shaped curve, wherein the bell-shaped curve can suggest an optimal range for the type of social channel usage and the frequency of the type of social channel usage to achieve the targeted outcome.

7. The method of claim 1 further comprises providing, by one or more computer processors, the one or more recommendations to the one or more employees through one or more interfaces including one or more of:
a dashboard;
an email;
a social usage profile attached to an employee profile; and
a pop up window.

8. A computer program product for recommending social channel usage to achieve a targeted outcome, the computer program product comprising:
one or more computer readable storage media and program instructions stored on the one or more computer readable storage media, the program instructions comprising:
program instructions to determine a plurality of social channel usage information for one or more employees;
program instructions to determine a plurality of outcome information for the one or more employees;
program instructions to determine, based, at least in part, on the plurality of social channel usage information and the plurality of outcome information for the one or more employees, one or more analytical models, wherein the one or more analytical models indicate patterns of social business usage for one or more employees achieving a targeted outcome; and
program instructions to determine, based, at least in part, on the one or more analytical models, one or more recommendations to achieve the targeted outcome,
wherein the program instructions are carried out by one or more computer processors.

9. The computer program product of claim 8, wherein program instructions to determine a plurality of social channel usage information, further comprising:
program instructions to retrieve, by one or more computer processors, a plurality of input information across one or more social business channels; and
program instructions to store, by one or more computer processors, the plurality of input information across the one or more social business channels in a master data repository, wherein the plurality of input information is stored with a unique identifier associated with each of the one or more employees.

10. The computer program product of claim 8, wherein program instructions to determine a plurality of outcome information, further comprising:
program instructions to retrieve, by one or more computer processors, a plurality of output information across one or more areas within an organization; and
program instructions to store, by one or more computer processors, the plurality of output information across the one or more areas within the organization in the master data repository, wherein the plurality of output information is stored with the unique identifier associated with each of the one or more employees.

11. The computer program product of claim 8, wherein program instructions to determine one or more analytical models, further comprising:
program instructions to retrieve, by one or more computer processors, the plurality of social channel usage information and the plurality of outcome information contained under the unique identifier for each of the one or more employees from the master data repository;
program instructions to determine, by one or more computer processors, a measure of a statistical significance of the plurality of social channel usage information relative to the plurality of outcome information;
program instructions to determine, by one or more computer processors, a measure of a strength of relationship between the plurality of social channel usage information and the plurality of outcome information; and
program instructions to determine, by one or more computer processors, based, at least in part, on the measure of the statistical significance and the measure of the strength of relationship, a correlation between the use of a particular social channel and a targeted outcome.

12. The computer program product of claim 8, wherein program instructions to determine one or more recommendations to achieve a targeted outcome, further comprising program instructions to determine, by one or more computer processors, based, at least in part, on the one or more analytical models, a combination and a frequency of social channel usage that provides a positive impact towards achieving a targeted outcome.

13. The computer program product of claim 12, wherein program instructions to determine a combination and a frequency of social channel usage, further comprising program instructions to determine, by one or more computer processors, one or more relationships between a type of social channel usage and the targeted outcome, including one or more of:
a positive linear relationship between the type of social channel usage and an increase in an occurrence of the targeted outcome, wherein the positive linear relationship can support a recommendation of increasing a frequency of the type of social channel usage to achieve the targeted outcome;
a negative linear relationship between social channel usage and a decrease in the occurrence of the targeted outcome, wherein the negative linear relationship supports a recommendation of decreasing the frequency of the type of social channel usage to achieve the targeted outcome; and
a bell-shaped curve, wherein the bell-shaped curve can suggest an optimal range for the type of social channel usage and the frequency of the type of social channel usage to achieve the targeted outcome.

14. The computer program product of claim 8 further comprises program instructions to provide, by one or more computer processors, the one or more recommendations to the one or more employees through one or more interfaces including one or more of:
a dashboard;
an email;
a social usage profile attached to an employee profile; and
a pop up window.

15. A computer system for recommending social channel usage to achieve a targeted outcome, the computer system comprising:
one or more computer readable storage media;
program instructions stored on at least one of the one or more computer readable storage media for execution by at least one of the one or more computer processors, the program instructions comprising:
program instructions to determine a plurality of social channel usage information for one or more employees;
program instructions to determine a plurality of outcome information for the one or more employees;
program instructions to determine, based, at least in part, on the plurality of social channel usage information and the plurality of outcome information for the one or more employees, one or more analytical models, wherein the one or more analytical models indicate patterns of social business usage for one or more employees achieving a targeted outcome; and
program instructions to determine, based, at least in part, on the one or more analytical models, one or more recommendations to achieve the targeted outcome,
wherein the program instructions are carried out by one or more computer processors.

16. The computer system of claim 15, wherein program instructions to determine a plurality of social channel usage information, further comprising:
program instructions to retrieve, by one or more computer processors, a plurality of input information across one or more social business channels; and
program instructions to store, by one or more computer processors, the plurality of input information across the one or more social business channels in a master data repository, wherein the plurality of input information is stored with a unique identifier associated with each of the one or more employees.

17. The computer system of claim 15, wherein program instructions to determine a plurality of outcome information, further comprising:
program instructions to retrieve, by one or more computer processors, a plurality of output information across one or more areas within an organization; and
program instructions to store, by one or more computer processors, the plurality of output information across the one or more areas within the organization in the master data repository, wherein the plurality of output information is stored with the unique identifier associated with each of the one or more employees.

18. The computer system of claim 15, wherein program instructions to determine one or more analytical models, further comprising:
program instructions to retrieve, by one or more computer processors, the plurality of social channel usage information and the plurality of outcome information contained under the unique identifier for each of the one or more employees from the master data repository;
program instructions to determine, by one or more computer processors, a measure of a statistical significance of the plurality of social channel usage information relative to the plurality of outcome information;
program instructions to determine, by one or more computer processors, a measure of a strength of relationship between the plurality of social channel usage information and the plurality of outcome information; and
program instructions to determine, by one or more computer processors, based, at least in part, on the measure of the statistical significance and the measure of the strength of relationship, a correlation between the use of a particular social channel and a targeted outcome.

19. The computer system of claim 15, wherein program instructions to determine one or more recommendations to achieve a targeted outcome, further comprising program instructions to determine, by one or more computer processors, based, at least in part, on the one or more analytical models, a combination and a frequency of social channel usage that provides a positive impact towards achieving a targeted outcome.

20. The computer system of claim 19, wherein program instructions to determine a combination and a frequency of social channel usage, further comprising program instructions to determine, by one or more computer processors, one or more relationships between a type of social channel usage and the targeted outcome, including one or more of:
a positive linear relationship between the type of social channel usage and an increase in an occurrence of the targeted outcome, wherein the positive linear relationship can support a recommendation of increasing a frequency of the type of social channel usage to achieve the targeted outcome;
a negative linear relationship between social channel usage and a decrease in the occurrence of the targeted outcome, wherein the negative linear relationship supports a recommendation of decreasing the frequency of the type of social channel usage to achieve the targeted outcome; and
a bell-shaped curve, wherein the bell-shaped curve can suggest an optimal range for the type of social channel usage and the frequency of the type of social channel usage to achieve the targeted outcome
